(19) United States
(12) Patent Application Publication
(10) Pub. No.: US 2017/0175735 A1
(43) Pub. Date: Jun. 22, 2017

(54) Internal Gear Pump

(71) Applicant: Robert Bosch GmbH, Stuttgart (DE)

(72) Inventors: Edgar Kurz, Heilbronn-Horkheim (DE); Massimiliano Ambrosi, Benningen (DE); Michael Eisenlauer, Affalterbach (DE); Norbert Alaze, Markgroeningen (DE); Wolf Stahr, Abstatt (DE)

(21) Appl. No.: 15/377,189

(22) Filed: Dec. 13, 2016

(30) Foreign Application Priority Data
Dec. 17, 2015 (DE) 10 2015 225 734.7

(51) Int. Cl. F04C 2/10; F16C 27/02; F16C 23/04

(52) U.S. Cl. CPC F04C 2/102; F16C 23/04; F16C 27/02; F04C 2240/30; F04C 2240/50; F16C 2220/42; F16C 2360/00

(57) ABSTRACT

An internal gear pump for a hydraulic vehicle brake system includes a bearing ring and a ring gear. The bearing ring is open at one point of a periphery of the ring. The opening is configured to slip-mount the ring gear with the internal gear pump. The bearing ring is formed from a bent sheet metal strip.

This application claims priority under 35 U.S.C. §119 to patent application no. DE 10 2015 225 734.7, filed on Dec. 17, 2015 in Germany, the disclosure of which is incorporated herein by reference in its entirety.

The disclosure concerns an internal gear pump. The internal gear pump is provided in particular as a hydropump for a hydraulic power brake and/or slip-controlled vehicle brake system.

### BACKGROUND

Internal gear pumps are known. They have a pump casing which houses a rotatably mounted ring gear which intermeshes with a gear wheel arranged therein, wherein typically the gear wheel is arranged rotationally fixedly on a pump shaft and, to operate the internal gear pump, is driven in rotation and in turn drives in rotation the ring gear intermeshing therewith.

Publication DE 197 10 804 A1 discloses an internal gear pump in which the ring gear is slip-mounted rotatably in a pump casing via a bearing ring closed in a peripheral direction.

### SUMMARY

The internal gear pump according to the disclosure has a bearing ring for slip-mounting of a ring gear in a pump casing, which bearing ring is open at one point of its periphery and is referred to in brief below also as an open bearing ring or simply as a bearing ring. Because of the open point, a circumference and a diameter of the bearing ring can easily be changed by a slight, preferably elastic deformation of the bearing ring, and the bearing ring can easily be inserted in the pump casing.

An internal gear pump also means an annular gear pump.

The disclosure describe advantageous embodiments and refinements of the disclosure.

An embodiment provides that an open peripheral point of the bearing ring lies outside the peripheral region in which the internal gear pump has a pressure chamber. The pressure chamber of an internal gear pump lies between the ring gear and the gear wheel which, when driven in rotation, deliver fluid into the pressure chamber and hence generate pressure in the pressure chamber. The pressure presses the ring gear outward in the region of the pressure chamber. The open peripheral point of the bearing ring therefore does not lie in the peripheral region in which the pressure in the internal gear pump presses the ring gear outward. The pressure chamber communicates with a pump outlet.

An embodiment of the disclosure provides an outwardly protruding rotation prevention element of the bearing ring which engages in a recess in the pump casing and hence holds the bearing ring rotationally fixedly in the pump casing. The rotation prevention ring may for example be an element arranged on the bearing ring, for example bolted, riveted or welded thereon. It is also possible to bend one or both ends of the open bearing ring outward as a rotation prevention element, or deform the bearing ring into an outwardly protruding U-shape at an arbitrary point on a periphery.

An embodiment of the disclosure provides that the bearing ring lies with pretension in the pump casing. This means that before installation in the pump casing, the bearing ring has a greater circumference and diameter than in the installed state, wherein for installation in the pump casing it is reduced in size, preferably elastically, which is easily possible because of its open peripheral point, so that on installation it lies in the pump casing under pretension from the inside.

An embodiment provides a spreading open of the bearing ring at its open peripheral point. For this, the ends of the bearing ring on both sides of the open peripheral point are pressed apart in the peripheral direction, for example with a spreader element such as a wedge, so that the bearing ring is firmly clamped in the pump casing.

In a simple fashion, the use of the bearing ring allows a coating and/or structuring of an inner peripheral face of the bearing ring which forms a slip face for the ring gear of the internal gear pump. The inner peripheral face of the bearing ring may have a wear protection and/or friction-reducing coating, or comprise indentations and/or grooves or similar to improve the adhesion of a lubricant, as a lubricant deposit and/or for distribution of lubricant on the inner peripheral face of the bearing ring. The lubricant is typically a fluid delivered by the internal gear pump, i.e. a brake fluid in a hydraulic vehicle brake system. Because the bearing ring is open, it may be bent into a ring from a flat strip. The coating or structuring is facilitated if it is performed on the flat strip instead of on an inner peripheral face of a ring.

### BRIEF DESCRIPTION OF THE DRAWINGS

The disclosure is explained in more detail below with reference to embodiments shown in the drawing, in which:

FIG. 1 shows a side view of an internal gear pump according to the disclosure;

FIG. 2 shows a variant of a detail according to arrow II in FIG. 1 according to the disclosure; and

FIGS. 3 and 4 show structured inner peripheral faces of a bearing ring of the internal gear pump from FIG. 1 according to the disclosure.

The drawing is a diagrammatic and simplified depiction for clarification and understanding of the disclosure.

### DETAILED DESCRIPTION

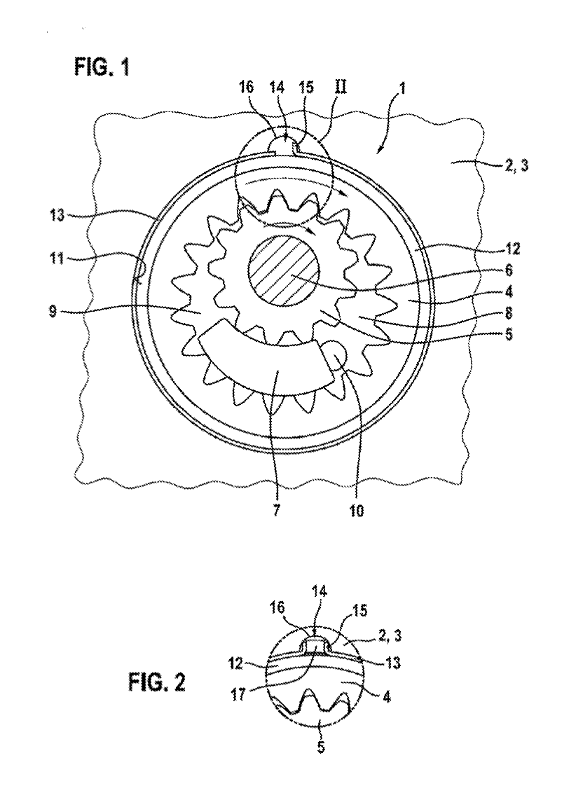

The internal gear pump 1 according to the disclosure, shown in FIG. 1, is arranged in a hydraulic block 2 of a slip control system of a hydraulic vehicle brake system (not otherwise shown); the hydraulic block 2 forms a pump casing 3 of the internal gear pump 1. The pump casing 3 contains a ring gear 4, i.e. an internally toothed gear wheel, and in the ring gear an externally toothed gear wheel 5 which intermeshes with the ring gear 4. The ring gear 4 and the gear wheel 5 may also be described as gear wheels or a gear set of the internal gear pump 1. The gear wheel 5 is arranged rotationally fixedly on a pump shaft 6 which is driven in rotation in order to operate the internal gear pump 1, whereby the co-rotating gear wheel 5 drives the ring gear 4 in rotation and the internal gear pump 1 delivers fluid in the known manner.

An arcuate separating piece 7 is arranged in a sickle-shaped intermediate space between the gear wheel 5 and the ring gear 4; the tooth tips of the teeth of the gear wheel 5 and the ring gear 4 lie on this piece and slide along this on operation of the internal gear pump 1. The separating piece 7, also called a sickle, separates the suction chamber 8 from the pressure chamber 9 in the intermediate space between the gear wheel 5 and the ring gear 4 of the internal gear pump 1. An end of the separating piece 7 on the suction chamber side rests as an abutment on a bolt 10 which passes transversely through the sickle-shaped intermediate space between the gear wheel 5 and the ring gear 4 in the suction chamber 8. A cover of the pump casing 3, which is removed in FIG. 1 and therefore not visible, comprises an inlet and an outlet. Because the cover has been removed, the pump casing 3 can be viewed from the side.

The pump casing 3 comprises a cylindrical cavity 11 in which the ring gear 4, the gear wheel 5 and the separating piece 7 are arranged. The ring gear 4 is pressed into a tire 12 which is a metallic ring that is wider than the ring gear 4, whereby a slide bearing face for rotational mounting of the ring gear 4 is wider than the ring gear 4. The tire 12 is rotatably slip-mounted in a bearing ring 13 which is as wide as the tire 12 and is arranged rotationally fixedly in the cavity 11 of the pump casing 3. The bearing ring 13 is bent into a ring from an originally flat sheet metal strip and is open at one point 14 of its periphery. Because of the open peripheral point 14, the bearing ring 13 is resilient in the circumferential and radial direction; in relaxed state outside the pump casing 3, it has a greater radius and diameter than the cavity 11 of the pump casing 3. For installation in the pump casing 3, the bearing ring 13 is compressed elastically to a smaller circumference and diameter, and springs open in the cavity 11 in the pump casing 3 so that it lies in the pump casing 3 with pretension.

One end at the open peripheral point 14 of the bearing ring 13 is bent outward as a rotation prevention element 15, and engages in a recess 16 in a periphery of the cylindrical cavity 11 of the pump casing 3, so that the bearing ring 13, as well as the pretension with which it lies in the pump casing 3, is also held rotationally fixedly in the pump casing 3 by the engagement of its rotation prevention element 15 in the recess 16.

In the variant shown in FIG. 2, both ends of the bearing ring 13 are bent outward and a spreader element 17 is inserted between the two ends of the bearing ring 13 which presses the ends of the bearing ring 13 apart, and hence presses the bearing ring 13 outward to clamp it fixedly in the pump casing 3.

The open peripheral point 14 of the bearing ring 13 lies opposite the separating piece 7, i.e. between the suction chamber 8 of the pressure chamber 9. In general, the open peripheral point 14 of the bearing ring 13 is situated outside a peripheral region in which the pressure chamber 9 is located. When, on operation of the internal gear pump 1, the gear wheel 5 is driven in rotation and also drives the ring gear 4 intermeshing therewith in rotation, the gear wheel 5 and the ring gear 4 deliver brake fluid from the suction chamber 8, past the separating piece 7 on the inside and outside, into the pressure chamber 9, and create a pressure in the pressure chamber 9 which presses the ring gear 4 outward in the region of the pressure chamber 9. The open peripheral point 14 of the bearing ring 13 does not lie in the peripheral region in which the ring gear 4 is pressed outward by the pressure in the internal gear pump 1.

The bearing ring 13 may be hardened or surface-hardened or have a wear-resistant and/or friction-reducing coating at least on its inner peripheral face. For example, a coating of plastic, for example PTFE, is possible as a friction-reducing coating.

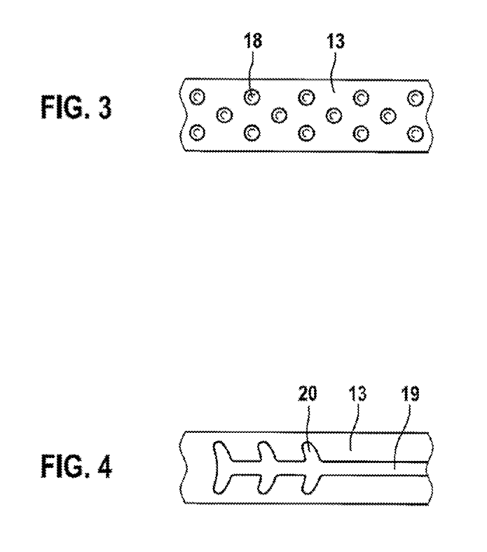

FIGS. 3 and 4 show peripheral faces of two bearing ring 13 according to the disclosure which have surface structures. In FIG. 3, the inner peripheral face of the bearing ring 13 has spot-like indentations 18 (“golf ball pattern”). The indentations 18 improve adhesion of the lubricant to the bearing ring 13 and form lubricant deposits, wherein the lubricant is brake fluid in a hydraulic vehicle brake system.

In FIG. 4, the inner peripheral face of the bearing ring 13 has a groove 19 running in a longitudinal center as a surface structure, from which short branches 20 run obliquely outward in a herringbone pattern. This surface structure 19, 20 distributes lubricant over the inner peripheral face of the bearing ring 13 in the longitudinal and transverse directions. It is also possible to slip-mount the gear wheel 4 rotatably, directly in the bearing ring 13 without a tire 12 (not shown).

What is claimed is:

1. An internal gear pump, comprising:
a pump casing;
a ring gear;
a gear wheel positioned inside of and intermeshing with the ring gear; and
a bearing ring that rotatably slip-mounts the ring gear in the pump casing, and that defines an opening at one point along a periphery of the bearing ring.

2. The internal gear pump of claim 1, wherein:
the internal gear pump defines a pressure chamber in a peripheral region; and
the open point along the periphery of the bearing ring is located outside of the peripheral region.

3. The internal gear pump of claim 1, wherein:
the pump casing defines a recess; and
the bearing ring includes a rotation prevention element that protrudes toward an outside and that is configured to engage the recess in the pump casing.

4. The internal gear pump of claim 1, wherein the bearing ring is positioned in the pump casing and is pretensioned.

5. The internal gear pump of claim 1, wherein the bearing ring is spread open at the open point along the periphery of the bearing ring.

6. The internal gear pump of claim 1, wherein the bearing ring is a bent strip of sheet metal.

7. The internal gear pump of claim 1, wherein the bearing ring includes a coating disposed on an inner peripheral face of the bearing ring.

8. The internal gear pump of claim 1, wherein an inner peripheral face of the bearing ring defines a surface structure.

9. The internal gear pump of claim 1, further comprising:
a tire that is rotatably slip-mounted in the bearing ring;
wherein the ring gear is rotationally fixed in the tire.
